(19) United States
(12) Patent Application Publication
(10) Pub. No.: US 2021/0138864 A1
(43) Pub. Date: May 13, 2021

(54) EMBEDDED SENSOR FOR LEAF SPRING SUSPENSION

(71) Applicant: RASSINI SUSPENSIONES, S.A. DE C.V., Col. Molino del Rey (MX)

(72) Inventors: Humberto Salazar Palafox, Piedras Negras (MX); Pablo Isaías Martinez Galván, Piedras Negras (MX); Juan Jose Wong Aguilera, Piedras Negras (MX); Eddy Alfaro Lopez, Piedras Negras (MX); Jose Guadalupe Ruiz Juarez, Piedras Negras (MX)

(21) Appl. No.: 17/092,581

(22) Filed: Nov. 9, 2020

Related U.S. Application Data
(60) Provisional application No. 62/932,092, filed on Nov. 7, 2019.

(51) Int. Cl. B60G 17/019

(52) U.S. Cl. CPC B60G 17/01941; B60G 2202/11; B60G 2204/11; B60G 17/01908

(57) ABSTRACT

A vehicle suspension system includes a leaf spring. The vehicle suspension system also includes a sensor embedded within the leaf spring and in operative communication with a vehicle system.

This application claims priority to U.S. Patent Application No. 62/932,092, filed Nov. 7, 2019, the disclosure of which is incorporated herein by reference in its entirety.

### FIELD OF THE INVENTION

### Field of the Invention

This invention relates generally to leaf spring suspension systems for vehicles and, more particularly, to embedded sensors for such suspension systems.

### Background

Leaf spring systems have for many years been used for the suspension of wheeled vehicles. The central element of a leaf spring suspension system for a vehicle is termed a “semi-elliptical” spring configured as an arc-shaped length of spring steel having a substantially rectangular cross-section. At or near the center of the arc is provided an arrangement for coupling to the axle of the vehicle. At the ends are provided coupler holes for attaching the spring to the vehicle body. For heavy vehicles, leaf springs are stacked on one another to form layers of springs of different lengths. Leaf springs are still used in heavy commercial vehicles and railway carriages. In the case of very heavy vehicles, leaf springs provide the advantage of spreading the load over a larger region of the vehicle's chassis.

Leaf spring suspension components include many characteristics, such as load, displacement and strain. Suspension components can also produce vibration, temperature changes, pressure, mechanical contact, deflection, inclination or tilt, magnetic response, or any kind of translational or rotational motion. Improvements related to monitoring these characteristics and efficiently utilizing the characteristic information is desired.

### SUMMARY OF THE INVENTION

According to one aspect of the disclosure, a vehicle suspension system is provided. The vehicle suspension system includes a leaf spring. The vehicle suspension system also includes a sensor embedded within the leaf spring and in operative communication with a vehicle system.

According to another aspect of the disclosure, a vehicle suspension system includes a leaf spring. The system also includes a sensor completely enclosed within the leaf spring and in electrical communication with a controller.

According to yet another aspect of the disclosure, a method of monitoring a vehicle suspension system is provided. The method includes communicating data detected by a sensor embedded within a leaf spring to a controller. The method also includes detecting at least one of vertical load, acceleration, braking, rolling over, twist, fore and aft impacts, and lateral loads with the data communicated from the sensor to the controller.

These and other advantages and features will become more apparent from the following description taken in conjunction with the drawings

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a leaf spring suspension component having an embedded sensor; and

FIG. 2 illustrates a variety of sensors that may be embedded in the leaf spring suspension component.

### DETAILED DESCRIPTION

Referring to FIG. 1, a portion of a leaf spring suspension component is illustrated and generally referenced with numeral 10. The leaf spring suspension component 10 may be formed from various materials, such as steel, aluminum, composite and/or any other material or combinations of materials. The leaf spring suspension component may be utilized in a vehicle suspension system (not shown). Any type of leaf spring suspension system may benefit from the embodiments disclosed herein. The leaf spring suspension component 10 may have an axle (not shown) operatively coupled to the leaf spring suspension component 10 at an intermediate portion of the leaf spring suspension component 10.

Irrespective of the type of suspension system that the leaf spring suspension component 10 is used within, the embodiments described herein include one or more sensors 12 embedded within the leaf spring suspension component 10. The sensor(s) 12 is integrated into the leaf spring suspension component 10 to capture and provide data to a vehicle system 14. The sensor 12 may be particularly useful in the context of the leaf spring suspension component 10 by detecting vertical load, acceleration, braking, rolling over, twist, fore and aft impacts, and lateral loads, for example.

The vehicle system 14 may utilize the data to evaluate, improve, analyze and/or control vehicle capacities and/or features, such as handling, comfort, safety, autonomy, leveling, failure prevention, damage analysis, driver evaluation, stability, and accident prevention due to roll over, skid, heavy cornering avoidance or other high risk conditions. The preceding list is merely illustrative of the features that may be influenced by the data acquisition provided by the sensor 12.

The analysis and/or control of the vehicle features is done by acting or communication between the sensor 12 and a controller 16 of the vehicle system 14, and subsequent communication between the controller processor 16 with active, semi-active or passive control elements for an engine, a transmission, a leveling system, a suspension, a steering system, a braking system and/or other vehicle subsystems. The sensor 12 communicates with the vehicle system 14 in a wired or wireless manner. The sensor 12 can receive its electrical power by wire to the vehicle, by wire to an external battery or with an internal battery.

The controller 16 may, for example, include a processor and a memory storing instructions that, when executed by the processor, allow the controller 16 to perform the analysis and command functions described herein. The processor may include any suitable processor, such as those described herein. Additionally, or alternatively, the controller 16 may include any suitable number of processors, in addition to or other than the processor. The memory may comprise a single disk or a plurality of disks (e.g., hard drives), and includes a storage management module that manages one or more partitions within the memory. In some embodiments, memory may include flash memory, semiconductor (solid state) memory or the like. The memory may include Random Access Memory (RAM), a Read-Only Memory (ROM), or a combination thereof. The memory may include instructions that, when executed by the processor, cause the processor to, at least, perform the various methods described herein.

As shown in FIG. 1, the leaf spring suspension component 10 has the sensor 12 integrated therein in an embedded manner. Embedding of the sensor 12 refers to the sensor 12 being disposed within the leaf spring suspension component 10. In some embodiments, the sensor 12 is completely within the leaf spring suspension component 10 in a manner that leaves the sensor 12 unexposed to the exterior of the leaf spring suspension component 10. Specifically, the sensor 12 is enclosed within the leaf spring suspension component 10. This defines a fully embedded sensor embodiment. In other embodiments, the sensor 12 is embedded in a manner that leaves the sensor at least partially exposed to the exterior of the leaf spring suspension component 10. In the exposed embodiments, the sensor is recessed from, or is oriented in a flush manner, with an outer surface 18 of the leaf spring suspension component 10. It is further contemplated that the sensor 12 is fixed to the outer surface 18 of the leaf spring suspension component 10.

The sensor 12 may be integrated into the leaf spring suspension component 10 via a number of contemplated processes. For example, the sensor 12 may be molded with the component 10, bonded to the component 10, bolted to the component 10, a plug in/out sensor, or attached in any other suitable manner.

The sensor 12 can provide digital or analog data to a data collection system 20 for storage, processing and/or analysis. The data collection system 20 is part of the leaf spring suspension component 10 in some embodiments. In other embodiments, the data collection system 20 is part of the vehicle system 14. A data display system may also be provided and is part of the leaf spring suspension component 10 or the vehicle system 14.

Referring now to FIG. 2, examples of the sensor(s) 12 that may be embedded in the leaf spring suspension component 10 are shown. The embedded sensor 12 may be a micro-electromechanical system (MEMS), a load monitoring strain sensor, an encoder, a wire potentiometer, an ultrasonic sensor, a miniature laser ride height sensor, a linear potentiometer, a rotary sensor with a lever, a mechanical position switch, and/or a magnetic position switch. The preceding list is merely illustrative of the types of sensors that may be embedded within the leaf spring suspension component 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Having thus described the invention, it is claimed:

1. A vehicle suspension system comprising:
a leaf spring; and
a sensor embedded within the leaf spring and in operative communication with a vehicle system.

2. The vehicle suspension system of claim 1, wherein the sensor is completely enclosed within the leaf spring.

3. The vehicle suspension system of claim 1, wherein the sensor is exposed to an exterior of the leaf spring.

4. The vehicle suspension system of claim 3, wherein the sensor is recessed from an outer surface of the leaf spring.

5. The vehicle suspension system of claim 3, wherein the sensor is flush with an outer surface of the leaf spring.

6. The vehicle suspension system of claim 1, wherein the sensor is at least one of a micro-electromechanical system (MEMS), a load monitoring strain sensor, an encoder, a wire potentiometer, an ultrasonic sensor, a miniature laser ride height sensor, a linear potentiometer, a rotary sensor with a lever, a mechanical position switch, and/or a magnetic position switch.

7. The vehicle suspension system of claim 1, wherein the sensor is in operative communication with a controller.

8. The vehicle suspension system of claim 7, wherein the sensor is in wired electrical communication with the controller.

9. The vehicle suspension system of claim 7, wherein the sensor is in wireless electrical communication with the controller.

10. The vehicle suspension system of claim 7, wherein the controller is in electrical communication with a data collection system.

11. A vehicle suspension system comprising:
a leaf spring; and
a sensor completely enclosed within the leaf spring and in electrical communication with a controller.

12. The vehicle suspension system of claim 11, wherein the sensor is at least one of a micro-electromechanical system (MEMS), a load monitoring strain sensor, an encoder, a wire potentiometer, an ultrasonic sensor, a miniature laser ride height sensor, a linear potentiometer, a rotary sensor with a lever, a mechanical position switch, and/or a magnetic position switch.

13. A method of monitoring a vehicle suspension system, the method comprising:
communicating data detected by a sensor embedded within a leaf spring to a controller; and
detecting at least one of vertical load, acceleration, braking, rolling over, twist, fore and aft impacts, and lateral loads with the data communicated from the sensor to the controller.

14. The method of claim 13, wherein the sensor is completely enclosed within the leaf spring.

15. The method of claim 13, wherein the sensor is exposed to an exterior of the leaf spring.

16. The method of claim 13, further comprising communicating processed data from the controller to a data collection system.

17. The method of claim 13, wherein the data is communicated from the sensor to the controller with a wired electrical connection.

18. The method of claim 13, wherein the data is communicated from the sensor to the controller with a wireless electrical connection.
